(19) United States
(12) Patent Application Publication
(10) Pub. No.: US 2011/0133450 A1
(43) Pub. Date: Jun. 9, 2011

(54) SECURITY SPLICING SYSTEM AND ALIGNED PIPES, AGAINST THE EXPANSION AND/OR CONTRACTION THEREOF

(76) Inventors: Elisabet Patricia Pires Cabado, Alella (Barcelona) (ES); Barbara Ines Pires Cabado, Alella (Barcelona) (ES)

(21) Appl. No.: 13/021,995

(22) Filed: Feb. 7, 2011

Related U.S. Application Data
(63) Continuation-in-part of application No. 12/400,103, filed on Mar. 9, 2009.

(30) Foreign Application Priority Data
Mar. 11, 2008 (ES) 200800702
Feb. 12, 2010 (ES) 201030197

(51) Int. Cl. F16L 23/00

(52) U.S. Cl. 285/365

(57) ABSTRACT

A security splicing system of aligned pipes against an expansion and/or contraction thereof has a double flange including two anchoring elements anchorable to an outer surface of ends of the pipes to he spliced and a water tight joining flange, and internal lock rings disposed correspondingly in an interior of the ends of the pipes to be spliced substantially underneath the anchoring elements and adjustable to abut against an inner face of the ends of the pipes thus preventing from the interior a deformation of the ends of the pipes under the action of a pressure applied by the anchoring elements from an exterior of the ends of the pipes.

### CROSS-REFERENCE TO RELATED APPLICATION

This application is a Continuation-In-Part of U.S. patent application Ser. No. 12/400,103 filed on Mar. 9, 2009. The above mentioned U.S. patent application, whose subject matter is incorporated herein by reference, provides the basis for a claim of priority of the invention under 35 USC 119(a)-(d).

The invention is also described in Spanish Patent Application ES201030197 filed on Feb. 12, 2010. This Spanish Patent Application, whose subject matter is incorporated here by reference, provides the basis for a claim of priority of invention under 35 U.S.C. 119(a)-(d).

### BACKGROUND OF THE INVENTION

The present invention relates to a security splicing systems of aligned pipes, against the expansion and/or contraction.

These systems are used to compensate possible aggressive action of the components of the splicing system on the aligned pipes to be spliced, and specifically in the case of pipes composed of polyethylene, without affecting the assembly due to the addition of a protection element

It is known in the splicing system to incorporate a double flange, composed of two anchoring elements solidly joined by means of rods and a water tight flange centrally disposed in the ends of the pipes to be joined.

These anchoring elements are firmly fastened to the outer surface of the pipes to be spliced, due to an anchoring profile disposed in its interior, in particular a serious of projections with a truncated cone-shaped profile fastened to the outer face of the pipes so that, on tightening the pressure screws of the exterior clasp, the projections are practically driven into the outer face of the pipe, guaranteeing sufficient anchoring to avoid any displacement.

With the pipes composed of polyethylene their dimensional ability and specifically their dimensional profile can be affected if a certain tightening action is exerted externally.

When the security splicing system disclosed in the U.S. patent application Ser. No. 12/400,103 is used, the above mentioned projections are essential to guarantee any linear displacement caused by the extensions or contractions due to changes in temperature. However, the action of the projections, in being driven into the outer surface of the pipes composed of polyethylene, may cause deformations in the structure of the pipes. Such deformations may cause a loss of watertightness in the spliced area of the aligned pipes.

### SUMMARY OF THE INVENTION

Accordingly, it is an object of the present invention to provide a security splicing system of aligned pipes, against the expansion and/or contraction thereof, which avoids the disadvantages of the prior art.

In keeping with these objects and with others which will become apparent hereinafter, one feature of the present invention resides, briefly stated, in a security splicing system of aligned pipes against an expansion and/or contraction thereof, comprising a double flange including two anchoring elements anchorable to an outer surface of ends of the pipes to be spliced and a watertight joining flange, and internal lock rings disposed correspondingly in an interior of the ends of the pipes to be spliced substantially underneath the anchoring elements and adjustable to abut against an inner surface of the ends of the pipes thus preventing from the interior a deformation of the ends of the pipes under the action of a pressure applied by the anchoring elements from an exterior of the ends of the pipes.

When a security splicing system of aligned pipes, against the expansion and/or contraction thereof is designed in accordance with the present invention, the above mentioned disadvantages are eliminated.

With the use of the internal lock ring disposed inside the ends of each of the pipes to be sliced and becoming, once positioned and adjusted by an expansion device, a compensation element of the external pressure applied to the pipes, deformation of the pipes is avoided and the dimensional stability of their diameters both external and internal, is maintained, to fully guarantee the watertightness and stability of the splice.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of an internal lock ring equipped with a single expansion device in accordance with the present invention in a security splicing system of aligned pipes, against the expansion and/or contraction thereof;

FIGS. 2 & 3 are elevational and plane views of the same lock ring in accordance with the present invention;

FIG. 4 is a perspective view of an internal lock ring provided with two expansion devices; and

FIG. 5 is a schematic view of a splicing system disposed at the ends of two spliced pipes, with the internal lock rings in accordance with the present invention.

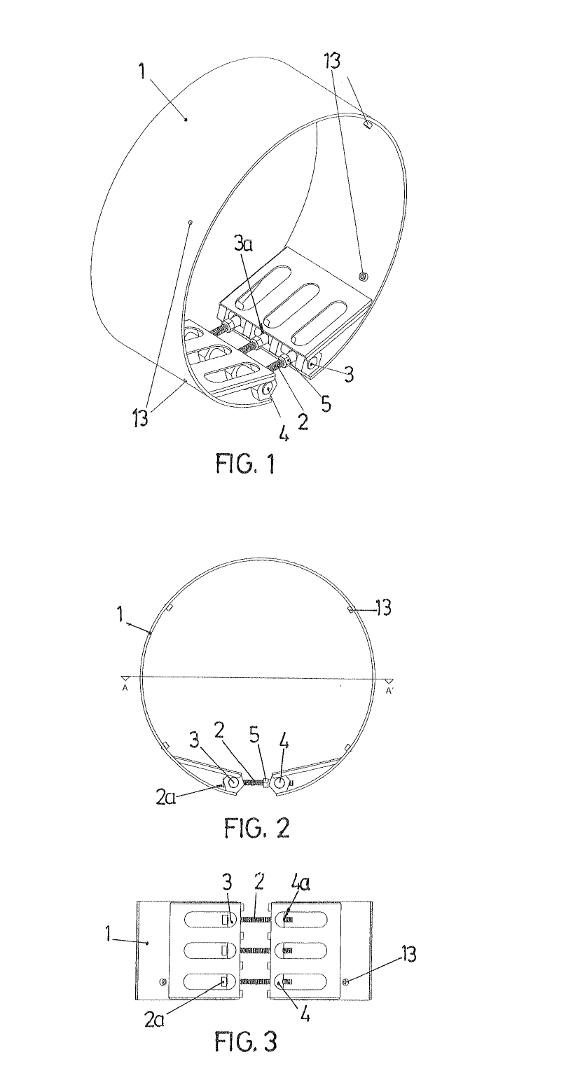

### DESCRIPTION OF THE PREFERRED EMBODIMENTS

In accordance with the present invention a security splicing system of aligned pipes includes a ring applied in an interior of an end of each of two polyethylene pipes to be spliced. The ring includes a rectangular stainless steel sheet (1), which is incomplete in an area where an expansion device is disposed. When the expansion device acts on the sheet (1) its aperture expands in diameter and it becomes strongly pressed against an inner face of the end of each of the pipes (6, 7) being spliced.

The expansion ring (1) is provided with a set of several identical screws (2) disposed in parallel through press-through openings (3a) of a spindle (3) which is transversely disposed at one of the open ends of the rectangular sheet (1). The screws (2) are retained by their respective screw heads (2a).

The screws (2) are threaded on the corresponding orifices (4a) of a spindle (4) which is disposed transversely and parallel to the spindle (3) at the opposite end of the rectangular sheet (1). The orifices (4a) of the spindle (4) are threaded with identical thread pitch as the screws (2) so that they are fastened by threading to the spindle (4).

By acting upon the respective expansion nuts (5) disposed on each of the screws (2), the necessary pressure is exerted upon the spindle (3) of the pass-through orifices (3a) causing the expansion of the ring (1) until it becomes strongly pressed against the inner face of the end of each of the pipes (6, 7). The rings (1) have been disposed at a moment of splicing by means of the device which is disclosed in the above mentioned U.S. patent application Ser. No. 12/400,103.

As shown in FIG. 5, the pipes (6, 7) are fastened by anchoring elements or flanges (8, 8a), together with a waterproof joining flange (9) disposed in the center of the assembly. Each of the anchoring flanges (8, 8a) have, on their inner face, a clasp (10) with a series of projections having a truncated cone-shaped structure (11), which on acting upon its own pressure screws of the anchoring flanges (8, 8a) are driven into the outer face of the pipes, thus avoiding the possibility of displacement.

The force exerted on each of the pipes (6, 7) at the moment the projections (11) are driven into their outer faces, is compensated by the stabilizing action of the rectangular metal sheet (1) of the inner ring, in accordance with the present invention, thus avoiding any deformation in the diametrical profile of each of the spliced polyethylene pipes.

Finally, several projecting fixing screws (13) are disposed on the rectangular stainless steel sheet (1) for preventing an accidental displacement of the ring along the interior of the pipe, once positioned against the inner face of the corresponding pipe.

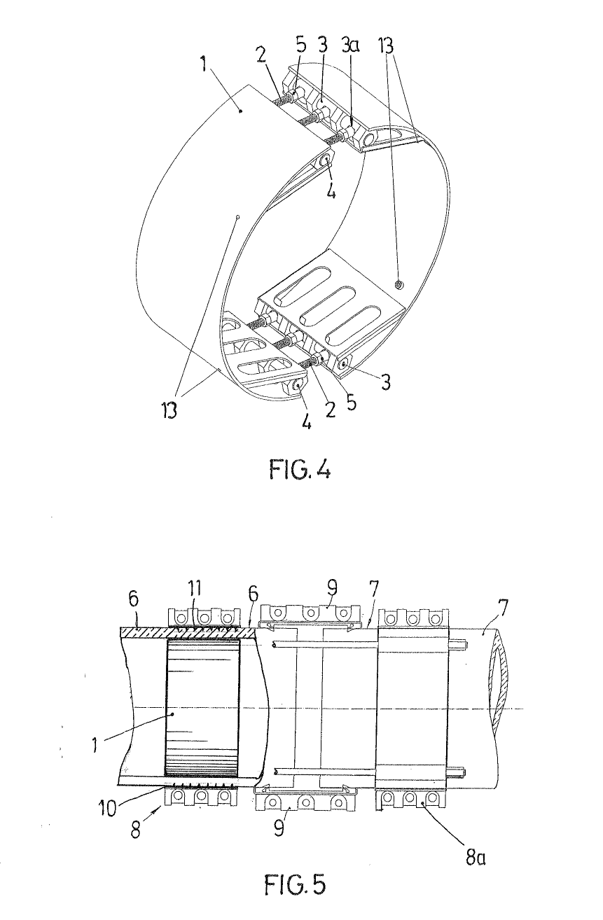

In accordance with another variant of the steel sheet (1), two expansion devices can be used as shown in FIG. 4. The two expansion devices can be identical and symmetrical and disposed in a diametrical position to each other as shown in this drawing.

It will be understood that each of the elements described above, or two or more together, may also find a useful application in other types of constructions differing from the types described above.

While the invention has been illustrated and described as embodied in a security splicing system of aligned pipes, against the expansion and/or contraction thereof, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A security splicing system of aligned pipes against an expansion and contraction thereof, comprising a double flange including two anchoring elements anchorable to an outer surface of ends of the pipes to be spliced and a water tight joining flange and internal lock rings disposed correspondingly in an interior of the ends of the pipes to be spliced substantially underneath the anchoring elements and adjustable to abut against an inner face of the ends of the pipes thus preventing from the interior a deformation of the ends of the pipes under the action of a pressure applied by the anchoring elements from an exterior of the ends of the pipes.

2. A security splicing system as defined in claim 1, wherein each of said internal lock rings is composed of a substantially rectangular stainless steel sheet which is incomplete in one area; further comprising an expansion device located in said area of each of said internal lock rings.

3. A security splicing system as defined in claim 2, wherein each of said sheets which constitute a respective one of said inner lock rings has projecting fixing screws positioned against the inner face of a respective one of the pipes so as to prevent displacement of the sheet.

4. A security splicing system as defined in claim 2, wherein each of said expansion devices includes two spindles disposed transversely on ends of the sheet, a plurality of screws disposed in orifices of one of the spindles and retained by screw heads and also threaded into orifices of the other of said spindles, so that by acting upon a nut of each of said screws, a pressure is exerted on one of said spindles causing an expansion of said sheet of the lock ring to be pressed against the inner face of the ends of each of the pipes.
